(19) United States
(12) Patent Application Publication
(10) Pub. No.: US 2014/0175065 A1
(43) Pub. Date: Jun. 26, 2014

(54) Welding-Current Control Method of the Resistance Welding Machine and Welding-Current Control Device

(71) Applicants: Tomiaki Hosokawa, Kani-shi (JP); Hiroyuki Kawaguchi, Kani-shi (JP); Yoshinori Ota, Kani-shi (JP)

(72) Inventors: Tomiaki Hosokawa, Kani-shi (JP); Hiroyuki Kawaguchi, Kani-shi (JP); Yoshinori Ota, Kani-shi (JP)

(73) Assignee: Nadex Products Co., Ltd., Kani-shi (JP)

(21) Appl. No.: 13/393,687

(22) PCT Filed: Jan. 26, 2012
(86) PCT No.: PCT/JP2012/051663

§ 371 Date: Mar. 1, 2012

(30) Foreign Application Priority Data
Aug. 30, 2011 (JP) 2011-187936

(51) Int. Cl. B23K 11/25

(52) U.S. Cl. CPC B23K 11/25
USPC 219/117.1

(57) ABSTRACT

In spot welding, the condition tolerance for applying a large current in a short time into an aluminum alloy plate or the like is narrow, and also nugget crack sometimes occurs in spot welding. In the case of a mild steel plate, the expulsion sometimes occurs, and thereby a poor weld portion is formed. Due to a pickup removal operation from an electrode tip, the operating ratio is reduced. Here, a PAM control method is employed for raising or dropping a rectified and smoothed voltage E_{DC} output to an inverter circuit, according to a certain set-up ratio in a predetermined time, instead of a conventional PWM control method. By this control method, the nugget can be formed in condition of low heat dissipation and high thermal efficiency. In addition, energy saving and power saving are achieved by using the PAM control method.

### TECHNICAL FIELD

This invention relates to a welding-current control method of a resistance welding machine which connects aluminum alloy plates, mild steel plates or the like, and a welding current device for performing the method.

Especially, this invention relates to the inhibition of an occurrence of a nugget crack during a spot welding of the aluminum alloy plates or the like, and relates to the inhibition of an occurrence of an expulsion during the spot welding of the mild-steel plates or the like.

### BACKGROUND ART

The resistance welding machine is for welding connected materials by applying the welding-current into the materials under applying pressure to the connected materials by holding the connected materials between upper and lower electrode tips.

The resistance welding machine comprises a rectifying-and-smoothing circuit for rectifying and smoothing an alternating voltage of a primary commercial power, an inverter circuit and a welding transformer driven by an output of the inverter circuit for outputting the welding-current into the electrode tips. For example, the following patent document 1 describes a control device for the resistance welding machine which uses a PWM (Pulse Width Modulation) control method.

### PRIOR ART DOCUMENT(S)

### Patent Document(s)

Patent document 1: JP Hei9-239555 A

### SUMMARY OF THE INVENTION

### Problems(s) to be Solved by the Invention

In the PWM control method, a power control of the welding-current Iw is performed by a pulse width modulation. When the welding-current is set to a small value, a period without current flow appears in every half-cycle of the welding-current, so heat dissipation occurs. As the result, it is necessary to extend a period of the resistance welding time.

For example, in the case of the spot welding of aluminum alloy plates, the heat dissipation from the materials is large. Therefore, a formation of the nugget requires flowing a large current for a short time, flowing a post-heating current to prevent the nugget crack, and a press forging control. It takes a large amount of time so as to decide conditions of an appropriate current range or the like, and also a condition tolerance of these conditions is narrow.

Also, in performing the spot welding of the mild steel plates or the like, a current value is raised to an approximate limit-value, at which the expulsion occurs, so as to obtain enough strength of joint. Therefore, there is sometimes a case that the expulsion occurs at the approximate limit-value, so a poor weld portion is formed because the intensity falls.

In addition, in the case of the spot welding of aluminum alloy, or in the case of the spot welding of the galvanized steel sheet or the like, a pickup is produced on the electrode tip. Therefore, an electrode-tip dressing or the like, or a replacing of the electrode tips having performed the welding more than a certain weld number of times is needed, and thereby the operating ratio is reduced.

Furthermore, in an inverter type direct-current-spot-welding machine or the like, a temperature of a semiconductor device is raised by switching loss of IGBT driving a welding transformer, a secondary rectifier diode or the like. Therefore, in the case of air-cooled type, the restriction of the activity ratio is needed. In addition, the large-sized fin or fan is required.

In addition, in an inverter type welding transformer, a hysteresis increases in proportion to frequency, and an eddy current loss increases in proportion to the square of frequency. In addition, as to flux density increasing in proportion to an applied voltage, the hysteresis increases in proportion to the power of 1.6 of the flux density, and the eddy current loss increases in proportion to the square of the flux density. Therefore, a consideration for cooling is required.

The present invention is for solving the above-mentioned conventional problems, and aims to provide a welding-current control method which enables to perform high-quality welding in which the thermal efficiency of the nugget is high, and a welding-current device for performing the method. For detail, the present invention prevents the occurrence of the nugget crack and the expulsion, and it can make the appropriate current range and the condition tolerance wide. In addition, the present invention aims to provide the welding-current control method of the resistance welding machine and the welding-current device for performing the method, which can reduce an electrode-tip impression depth formed on the connected materials, a pickup formed on the electrode tip, a switching loss of the control device (timer), and a core loss of the welding transformer, respectively.

### Means to Solve the Problem(s)

To achieve the above aims, the present invention enables a value of the welding-current to be controlled by a PAM (Pulse Amplitude Modulation) control method instead of a conventional PWM control system. For detail, the present invention provides a welding-current control method of a resistance welding machine which welds connected materials by applying the welding-current into the materials by the welding transformer under applying pressure to the connected materials by holding the connected materials between upper and lower electrode tips, wherein the resistance welding machine comprises (1) a rectifying-and-smoothing circuit rectifying and smoothing the alternating voltage of primary commercial power, and outputting a rectified-and-smoothed voltage E_{DC} (hereinafter referred to as “voltage E_{DC}”) which is a variable output, and (ii) an inverter circuit driving the welding transformer in response to the voltage E_{DC}, and wherein the method comprises a step of varying the welding-current by applying the voltage E_{DC}, which is raised or dropped according to a certain set-up ratio in a predetermined time after a set-up time has passed after a power-on, into the inverter circuit driving the welding transformer.

In the above-mentioned welding-current control method of the resistance welding machine, the present invention is characterized in that the raise or drop of the voltage E_{DC} is performed when a voltage across the electrode tips is larger than the reference value.

In the above-mentioned welding-current control method of the resistance welding machine, the present invention is characterized in that the raise, drop, down slope, or power-off of the voltage E_{DC} is performed when the period in which the voltage level across the electrode tips is beyond a predetermined reference value is beyond a predetermined time.

In the above-mentioned welding-current control method of the resistance welding machine, the present invention is characterized in that the voltage E_{DC} is raised or dropped during the predetermined time according to the set-up ratio on the basis of an identification of the connected materials, wherein the identification is performed by selecting the connected materials from predetermined materials by means of the voltage across the electrode tips detected in response to the power-on.

In the above-mentioned welding-current control method of the resistance welding machine, the present invention is characterized in that a constant heat input control for forming the nugget at a connected portion of the connected materials is performed by raising or dropping the voltage E_{DC} on the basis of a comparison between (i) the voltage across the electrode tips and (ii) a predetermined reference voltage, at every unit time after the power-on.

In addition, the present invention provides a welding-current control device of a resistance welding machine which welds connected materials by applying the welding-current into the materials by the welding transformer under applying pressure to the connected materials by holding the connected materials between upper and lower electrode tips, wherein the resistance welding machine comprises a rectifying and smoothing circuit rectifying and smoothing the alternating voltage of primary commercial power, and outputting a voltage E_{DC} which is a variable output, and an inverter circuit driving the welding transformer in response to the voltage E_{DC}, and wherein the resistance welding machine performs a method according to any one of above mentioned methods.

In the welding-current control device of the resistance welding machine, it is characterized in that the rectifying and smoothing circuit comprises a boost chopper circuit comprising (i) reactors inserted in each of the primary power supply input line and (ii) the high speed diodes and IGBTs substituted for diodes and SCRs configuring a hybrid-bridge-rectifier; and the rectifying and smoothing circuit outputs the voltage E_{DC} into the inverter circuit.

In the welding-current control device of the resistance welding machine, it is characterized in that the resistance welding machine comprises a step-down chopper circuit which receives an output of the rectifying and smoothing circuit, and the resistance welding machine outputs an output of the step-down chopper circuit into the inverter circuit.

### Effect of the Invention

According to the present invention, the period without current flow becomes very short regardless of a value of the welding-current, due to varying the welding-current of secondary side of the welding transformer by changing a voltage of primary side of the welding transformer, which is connected with the inverter circuit, under the PAM control method. Therefore, thermal efficiency is improved and thereby a welding using large current in short-time can be performed. In addition, the appropriate current range is made wide, so the condition tolerance can be made wide.

Due to these effects, the welding-current control method of the resistance welding machine and the welding-current device for performing the method, of the present invention, can provide the welding⁻current with little heat dissipation so as to form the optimal nugget even in a period of generating the nugget, by means of varying the rectified-and-smoothed voltage E_{DC}. Therefore, varying the rectified-and-smoothed voltage E_{DC} according to generation of the nugget can solve the problems of (1) the nugget crack of the spot welding of the aluminum alloy plate or the like, (ii) the strength reduction by the expulsion of the spot welding of the mild steel plate or the like, and (iii) the poor weld.

In addition, since the welding is completed for a short time, the temperature raise of surfaces of the connected materials and the electrode tip can also be reduced. Therefore, the occurrence of the pickup on the electrode tip can also be reduced.

In addition, since the welding-current is varied by changing the value of the voltage of primary side of the welding transformer, the switching loss of the semiconductors, such as IGBT, and the core loss of the welding transformer are reduced significantly when the inverter circuit is driven at 60% to 70% of the rated current generally used. Therefore, the activity ratio of an air-cooled welding machine can be improved.

### BRIEF DESCRIPTION OF THE DRAWING(S)

FIG. 1 is a configuration diagram showing a schematic diagram of the resistance welding machine which performs the welding-current control with reference to the one embodiment of the present invention.

FIG. 2 is a graph showing the relationship between an instruction E_{S}(V), which sets up a value of the resistance welding-current Iw(A), and E_{DC}(V).

FIG. 3(a) is a graph showing the relationships between (i) power-on signal tw(cycle) and the welding pressure F (kgf) and (ii) E_{DC}(V) and the welding-current Iw (A), in the case of the aluminum alloy sheet.

FIG. 3(b) is a graph showing the relationships between (i) power-on signal tw(cycle) and the welding pressure F (kgf) and (ii) E_{DC}(V) and the welding-current Iw (A), in the case of the mild steel plate.

FIG. 4 is a comparative explanatory chart illustrating the welding-current waveform of each half-cycle when the welding-current is changed to a certain value, according to PWM control method and PAM control method.

### DESCRIPTION OF EMBODIMENT(S)

The welding-current control method of the resistance welding machine and the welding-current device for performing the method, with reference to the one embodiment of the present invention, are characterized in an exchanging the welding-current control method of the inverter controlled direct-current-spot-welding machine from the conventional PWM (pulse width modulation) method into the PAM (pulse-amplitude modulation) method so as to advance the SCR ignition phase (or broaden the conduction angle) of a hybrid-bridge-rectifier in response to an instruction E_{S} which sets up a value of the welding-current, and thereby increase the rectified-and-smoothed voltage E_{DC}(V).

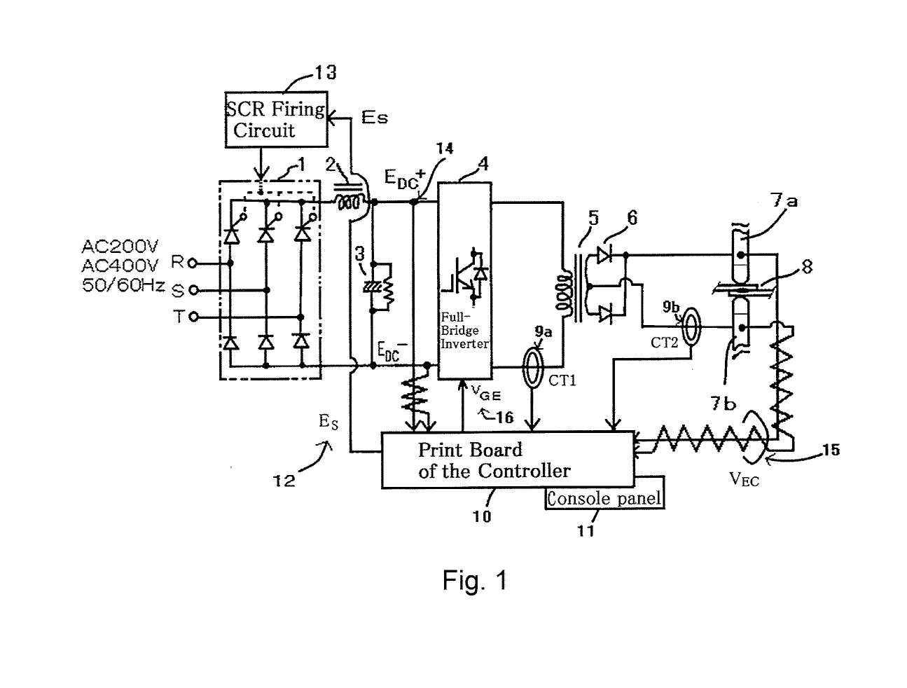

FIG. 1 shows the schematic diagram of one embodiment of the resistance welding machine. The resistance welding machine is configured to vary the rectified-and-smoothed voltage E_{DC} by giving the firing-signals into a SCR of the hybrid-bridge-rectifier 1 through the SCR firing-circuit 13, in response to the instruction E_{S} outputted from the printed board 10 of the controller.

Primary commercial power such as three-phase AC200V, 50/60 Hz or AC400V, 50/60 Hz is applied into the hybrid-bridge-rectifier 1 comprising the thyristors and the diodes. The output of the hybrid-bridge-rectifier 1 is smoothed by means of a reactor 2 and a smoothing capacitor 3, so as to generate a rectified-and-smoothed voltage E_{DC} (as shown by the arrow 14). For example, the hybrid-bridge-rectifier 1, the reactor 2, the smoothing capacitor 3, and the SCR firing-circuit 13 configure a rectifying and smoothing circuit wherein the circuit outputs the rectified-and-smoothed voltage E_{DC}, which is a variable output voltage, generated by rectifying and smoothing the primary commercial AC power. The rectified-and-smoothed voltage E_{DC} (hereafter, only referred to as “E_{DC}”) is applied into an inverter circuit 4 comprising IGBT or the like. The inverter circuit 4 drives a welding transformer 5.

A secondary output of the welding transformer 5 is applied into a center tap rectifier diode 6. An output of the rectifier diode 6 flows the welding-current in the form of direct current into the connected materials 8 through the up-and-down electrode tips 7a, 7b, so as to weld the connected materials 8. In addition, a primary current-transformer CT1 (as shown by the arrow 9a) is connected to the circuit at a primary side of the welding transformer 5, and a secondary current-transformer CT2 (as shown by the arrow 9b) is connected to the circuit at a secondary side of the welding transformer 5, wherein outputs of the primary current-transformer CT1 and the secondary current-transformer CT2 are applied into the printed board 10 of the controller. In addition, voltage V_{EC} across the electrode tips (as shown by the arrow 15) is applied into a printed board 10 of the controller through the twisted pair cable.

In response to a signal from a console panel 11 or an external I/O circuit (not shown), the printed board 10 of the controller gives a gate signal V_{GE} (as shown by arrow 16) to the inverter circuit 4 so as to drive the welding transformer 5.

The printed board 10 of the controller outputs the instruction E_{S} (as shown by the arrow 12), which adjusts a value of the welding-current, into the SCR firing-circuit 13. The SCR firing-circuit 13 outputs an firing-pulse into the SCR on the basis of the comparison between (i) a saw-tooth-waveform having a decreasing incline and (ii) the instruction E_{S}, at each cycle of the RST(reset-set trigger) signal generated by primary commercial power. In addition, the SCR firing-pulse may be generated by software processing in the printed board 10 of the controller. In this case, the printed board 10 outputs the SCR firing-pulse.

That is, the printed board 10 of the controller drives the inverter circuit 4 and the welding transformer 5 by means of the control of the SCR firing-circuit 13 by the instruction E_{S}, and thereby the welding-current is sent to the connected materials through the rectifier diode 6 and the electrode tips 7a, 7b. The printed board 10 of the controller outputs the instruction E_{S} so as to raise or drop the rectified-and-smoothed voltage E_{DC} with a certain set-up ratio during a set-up time when a set-up time has passed after the power-on, and thereby varies the welding-current.

In addition, the welding-current is varied by varying the value of the primary side voltage of the welding transformer 5. Therefore, in the case of driving the inverter circuit 4 in 60%-70% of the rated current generally used, the switching loss of the semiconductors, such as IGBT, and the core loss of the welding transformer 5 are substantially reduced. As the result, the activity ratio in the case of air-cooled type can be improved.

In a configuration of one embodiment of the present invention as shown in FIG. 1, the E_{DC} is varied by applying the firing-signals to SCR of the hybrid-bridge-rectifier 1 from the firing-circuit 13 according to an instruction E_{S}. Conventionally, in order to prevent the inrush current inrushing into the smoothing capacitor 3 at a time of the power-on of the primary source, SCR of the hybrid-bridge-rectifier 1 is used.

The printed board 10 of the controller varies an instruction E_{S} according to a value of the welding-current, and thereby varies the firing-phase of SCR of the hybrid-bridge-rectifier 1 by means of the SCR firing-circuit 13 as described above, and thereby varies the value of the E_{DC}. Although the value of the welding-current is set by the value of E_{DC}, a constant current control of the welding-current is additionally performed on the basis of the output of the primary current-transformer CT1 or the secondary current-transformer CT2, in response to the impedance change during the forming of the nugget of the connected materials 8.

In addition, the rectified-and-smoothed voltage E_{DC} may be varied by a boost chopper circuit instead of a hybrid-bridge-rectifier 1, wherein the boost chopper circuit comprises (i) reactors inserted in each of the primary power RSTs, (ii) high speed diodes substituted for SCRs of the hybrid-bridge-rectifier 1, and (iii) IGBTs substituted for the diodes of the hybrid-bridge-rectifier 1.

In addition, the resistance welding machine may comprise a step-down chopper circuit which receives the output of E_{DC} as shown in FIG. 1, and thereby the resistance welding machine outputs an output of the step-down chopper circuit as E_{DC}.

The printed board 10 of the controller raises or drops the E_{DC} according to a certain set-up ratio in a predetermined time after a set-up time is passed after a power-on. However, the printed board 10 may vary the E_{DC} so as to raise or drop when the voltage across the electrode tips 7a, 7b becomes larger than the reference value.

In addition, the raise, drop, down slope, or power-off of the E_{DC} may be performed when the period in which the voltage level across the electrode tips is beyond a predetermined reference value is beyond a predetermined time.

In addition, the rectified-and-smoothed voltage E_{DC} may be raised or dropped during the predetermined time according to the set-up ratio of, for example, the corresponding pattern on the basis of an identification of the connected materials, wherein the identification is performed by selecting the connected materials 8 from predetermined materials, such as aluminum alloy plate or mild steel plate or the like, by means of the voltage across the electrode tips detected in response to the power-on.

Above described process may be embodied by a software process performed by the arithmetic processing system comprising CPU or the FPGA, for example, in the printed board 10 of the controller. With reference to other processes, the similar embodiment can be employed.

In addition, the voltage across the electrode tips is detected, and then a constant heat input control for forming the nugget at a connected portion of the connected materials may be performed by raising or dropping the rectified-and-smoothed voltage E_{DC} on the basis of a comparison between (i) the detected voltage across the electrode tips and (ii) a predetermined reference voltage, at every unit time after the power-on.

In addition, unlike the PAM control method used for the consumer compressor or the like, since the PAM control method of the present invention and its device are original, the method is named O-PAM (which pronounces with “OU-PAM”) control method as a brand name, and it also name the product's name “The welding-current control device of the resistance welding machine using O-PAM control method”.

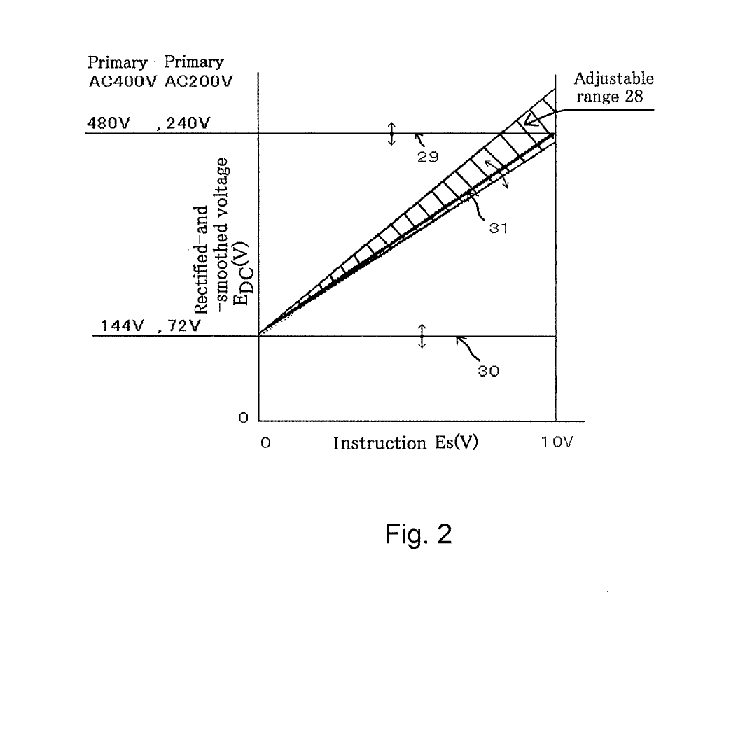

FIG. 2 shows a diagrammatic chart showing the relationship between the instruction E_{S}(V) and E_{DC} deciding the value of the welding-current in one embodiment of the present invention. The maximum value indicated by the arrow 29, the minimum value shown by the arrow 30, and the proportionality factor indicated by the arrow 31 are variable values. For example, the above-mentioned values are variable within the adjustable range 28 illustrated with parallel slant.

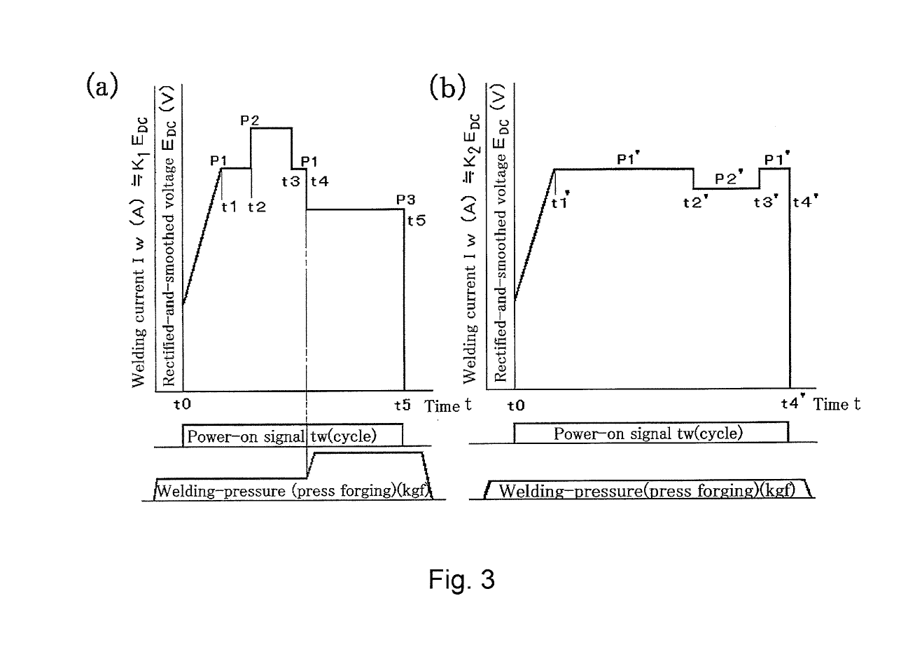

FIG. 3(a) and FIG. 3(b) illustrate the welding-current control method of one embodiment of the present invention. FIG. 3(a) is a time chart showing the time-dependent change, between (i) the welding-current Iw (A) and the rectified-and-smoothed voltage E_{DC}(V) and (ii) power-on signal tw(cycle) and the welding pressure F (kgf), with respect to the connected materials 8 in the case of the aluminum alloy sheet. FIG. 3(b) is a time chart showing the time-dependent change, between (i) the welding-current Iw (A) and the rectified-and-smoothed voltage E_{DC}(V) and (ii) power-on signal tw(cycle) and the welding pressure F (kgf), with respect to the connected materials 8 in the case of the mild steel plate.

As shown in FIG. 3(a), a contact resistance part of the connected aluminum alloy plates is made fit during 0.5 cycles of a rise slope period of t₀-t₁. In 1 cycle of a period of t₁-t₂, an initial state of the nugget as an origin of the nugget is formed by E_{DC} of a value P1. Next, in 2 cycles of a period of t₂-t₃, a corona bond of the nugget is quickly grown up by using a large current corresponding to E_{DC} of a value P2. Then, in 0.5 cycles of a period of t₃-t₄, a formation of the nugget is stabilized at E_{DC} of the above-mentioned initial value P1, and thereby the strong and homogeneous nugget is obtained. Also, post-heating current is applied to the nugget at E_{DC} of a value P3 during 4 cycles of a period of t₄-t₅. In addition, the crack of the nugget is removed by the press forging control method.

When the connected materials 8 is a piled-up 1.6 t-thickness aluminum alloy plate, one example of the welding condition of the direct-current welding-current of an aluminum alloy plate is as follows; the rise slope period t₀-t₁ is 0.5 cycles, the period t₁-t₂ for forming the origin of the nugget is 1.0 cycle at 43,000 (A), the period t₂-t₃ for forming the corona bond is 2.0 cycles at 49,000 (A), the period t₃-t₄ for forming the stabilized nugget is 0.5 cycles at 43,000 (A), and the period t₄-t₅ for applying the post-heating current is 4 cycles at 36,000 (A). The total resistance welding time is 0.5+1.0+2.0+0.5+4=8 cycles.

One example of the conventional welding condition is as follows; the welding-current 43,000 (A) and welding-pressure 500 (kgf) is set in 5 cycles, then the post-heating current 36,000 (A) and welding-pressure (press forging) 13,000 (kgf) is set in 5 cycles. A period necessary for the control method of the present invention consists of 2 less cycles than a period of the conventional case.

As shown in FIG. 3(b), a contact resistance part of the connected mild steel plates is made fit during 1 cycle of a rise slope period of t₀′-t₁′. In 8 cycles of a period of t₁′-t₂′, the corona bond of the nugget is grown up by using a current corresponding to E_{DC} of a value P1′. Next, in 3 cycles of a period of t₂′-t₃′, the corona bond is continuously grown up by using a current corresponding to E_{DC} of a value P2′ at which the expulsion can be prevented. And then, in 1 cycle of a period of t₃′-t₄′, the formed nugget is stabilized.

When the connected materials 8 is a piled-up 1.6 t-thickness mild steel plate, one example of the welding condition of the direct-current welding-current of an mild steel plate is as follows; the rise slope period of t₀′-t₁′ is 1 cycle, the period of t₁′-t₂′ for forming the nugget and growing up of the corona bond is 8 cycles at 9,000 (A), the period of t₂′-t₃′ for forming the nugget and growing the corona bond is 3 cycles at 8,100 (A) at which the expulsion can be prevented, and the period of t₃′ -t₄′ for forming the stabilized nugget is 1 cycle at 9,000 (A). The total resistance welding time is 1.0+8.0+3.0+1.0=13 cycles.

One example of the conventional welding condition is 16 cycles, the welding-current 11,500 (A) and the welding-pressure 360 (kgf). A period necessary for the control method of the present invention consists of 3 less cycles than a period of the conventional case.

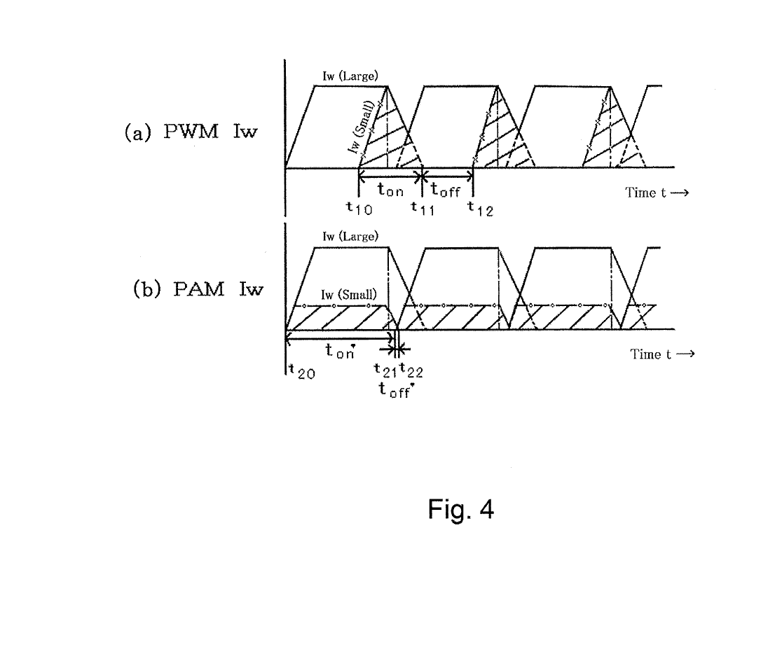

So as to compare between PWM (pulse width modulation) control method and PAM (pulse-amplitude modulation) control method, FIG. 4 shows a comparative explanatory chart illustrating the welding-current waveform of each half-cycle of times when the welding-current is changed from one value to the other. FIG. 4(a) shows waveforms of the welding-current Iw by PWM control method, and FIG. 4(b) shows waveforms of the welding-current Iw by PAM control method. Each of FIGS. 4(a)(b) shows two waveforms; one waveform is obtained at large welding-current Iw, and the other waveform is obtained at small welding-current Iw. As shown in FIG. 4(a), when the welding-current is set to small value, a period of flowing the welding-current is tₒₙ(t₁₀-t₁₁). A period of not flowing the welding-current is t_{off} (t₁₁-t₁₂). In FIG. 4(b), similarly, when the welding-current is set to small value, a period of flowing the welding-current is tₒₙ′ (t₂₀-t₂₁). A period of not flowing the welding-current is t_{off}′ (t₂₁-t₂₂).

So as to clarify the difference of the welding-current waveform between the conventional PWM control and the PAM control of the present invention, FIG. 4 shows the welding-current waveforms obtained at the time when a mechanical size of the secondary circuit of the welding transformer i.e. secondary inductance is small.

In FIG. 4, in response to decrease of the value of the welding-current, the period t_{off} in which the welding-current is not flowing of each half-cycle of the welding-current waveform increases, according to the conventional PWM control of FIG. 4(a).

In the period of t_{off}, heat input is dissipated into welded materials and the electrode tips. That is, in comparison with the heat input of the welding-current applied into the connected materials, the heat input affecting the formation of the nugget becomes low.

In other words, the thermal efficiency to the nugget is low.

In contrast to the conventional case, according to the PAM control of the present invention shown in FIG. 4(b), the period t_{off}′ in which the welding-current is not flowing of each half-cycle of the welding-current waveform is very short as illustrated.

As the result, amount of heat dissipation is quite low. That is, the heat input affecting the formation of the nugget by comparison with the above-mentioned heat input is high and thereby the thermal efficiency is high. In other words, the PAM control method can make the resistance welding time for forming the nugget short.

In addition, since the heat input affecting the formation of the nugget is high and the thermal efficiency is high, a temperature increase at the electrode tips and the upper and lower surfaces of the connected materials can be reduced by comparison with that of the conventional PWM control method. Therefore, together with the effect of the shortening of the period of the resistance welding time, the larger welding-current can be applied.

In addition, the pickup to the electrode is reduced because the above-mentioned temperature increase is reduced. In addition, thereby, the weld-able number of times can be increased.

In addition, due to the same reasons, the impression depth and concave formed on the electrode tips can be made shallow, and the uplift of the board of the connected materials can also be reduced.

As described above, according to the method of the present invention, the formation of the nugget can be performed with high thermal efficiency, the switching loss of the device and the core loss of the welding transformer can also be reduced, and therefore there is a high industrial usability due to the capabilities of the energy saving and power saving.

In addition, the method of the present invention can be applied to welding of the duralumin plates being a kind of the aluminum alloy, or welding of the galvanized steel sheets, or the method can also be applied to a seam welder for welding the thick plates which require a long resistance welding time.

In addition, the case of the servo pressure system, which uses a servo motor at the pressure head element, can form the strong and more homogeneous nugget, and thereby the condition tolerance can also be made widely. In addition, since the thermal efficiency is high, the welding of sheet steel piled up by three-sheet can be performed certainly. In addition, the welding method of the present invention can be substituted for a mechanical crimping for connecting the dissimilar metals, for example, the copper alloy or the like. In addition, the welding method of the present invention can be applied to the bimetal or the connection of the switch between the contact point and the lever. In addition, according to the method of the present invention, the nugget can be formed by means of small welding-current because thermal efficiency is high, and thereby it can make the usable range of the welding-current of one welding device significantly wide, and thereby the economic efficiency and the reducing capability of occupied space of the above-mentioned welding machine are improved.

### INDUSTRIAL APPLICABILITY

The method of the present invention can also be applied to the inverter type alternating-current-resistance welder. In addition, the method can be applied to the welding of the precision accessories, the thin objects and the dissimilar metal which use the small range of the welding-current.

As described above, by the method of the present invention, the nugget can be formed with high thermal efficiency, the switching loss of the device and the core loss of the welding transformer can be reduced, and the capability of energy saving and power saving can be improved, and therefore the present invention has a significant industrial usability.

### DESCRIPTION OF REFERENCE NUMERALS

1 Hybrid-bridge-rectifier
2 Reactor
3 Smoothing Capacitor
4 Inverter Circuit
5 Welding Transformer
7a, 7b Electrode tip
8 Connected materials
13 SCR Firing-circuit

1. A welding-current control method of a resistance welding machine which welds connected materials by applying the welding-current into the materials by the welding transformer under applying pressure to the connected materials by holding the connected materials between upper and lower electrode tips, wherein
the resistance welding machine comprises a rectifying and smoothing circuit rectifying and smoothing the alternating voltage of primary commercial power, and outputting a rectified and smoothed voltage E_{DC} (hereinafter referred to as “voltage E_{DC}”) which is a variable output, and an inverter circuit driving the welding transformer in response to the voltage E_{DC}, and wherein
the method comprises a step of varying the welding-current by applying the voltage E_{DC}, which is raised or dropped according to a certain set-up ratio in a predetermined time after a set-up time has passed after a power-on, into the inverter circuit driving the welding transformer.

2. The welding-circuit control method of the resistance welding machine of claim 1, wherein the raise or drop of the voltage E_{DC} is performed when a voltage across the electrode tips is larger than the reference value.

3. The welding-circuit control method of the resistance welding machine of claim 2, wherein the raise, drop, down slope, or power-off of the voltage E_{DC} is performed when the period in which the voltage level across the electrode tips is beyond a predetermined reference value is beyond a predetermined time.

4. The welding-circuit control method of the resistance welding machine of claim 3, wherein the voltage E_{DC} is raised or dropped during the predetermined time according to the set-up ratio on the basis of an identification of the connected materials, wherein the identification is performed by selecting the connected materials from predetermined materials by means of the voltage across the electrode tips detected in response to the power-on.

5. The welding-circuit control method of the resistance welding machine of claim 4, wherein a constant heat input control for forming the nugget at a connected portion of the connected materials is performed by raising or dropping the voltage E_{DC} on the basis of a comparison between (i) the voltage across the electrode tips and (ii) a predetermined reference voltage, at every unit time after the power-on.

6. A welding-current control device of a resistance welding machine which welds connected materials by applying the welding-current into the materials by the welding transformer under applying pressure to the connected materials by holding the connected materials between upper and lower electrode tips, wherein
the resistance welding machine comprises a rectifying and smoothing circuit rectifying and smoothing the alternating voltage of primary commercial power, and outputting a voltage E_{DC} which is an output voltage, and an inverter circuit driving the welding transformer in response to the voltage E_{DC}, and wherein,
the resistance welding machine performs a method of claim 1.

7. The welding-current control device of the resistance welding machine of claim 6, wherein the rectifying and smoothing circuit comprises a boost chopper circuit comprising (i) reactors inserted in each of the primary power supply input line and (ii) the high speed diodes and IGBTs substituted for diodes and SCRs configuring a hybrid-bridge-rectifier; and the rectifying and smoothing circuit outputs the voltage E_{DC} into the inverter circuit.

8. The welding-current control device of the resistance welding machine of claim 6, wherein the resistance welding machine comprises a step-down chopper circuit which receives an output of the rectifying and smoothing circuit, and the resistance welding machine outputs an output of the step-down chopper circuit into the inverter circuit.
